(19) United States
(12) Patent Application Publication
(10) Pub. No.: US 2025/0283337 A1
(43) Pub. Date: Sep. 11, 2025

(54) Adjustable Notched Trowel

(71) Applicant: Stefan Wild, Winter Garden, FL (US)

(72) Inventor: Stefan Wild, Winter Garden, FL (US)

(21) Appl. No.: 18/350,736

(22) Filed: Jul. 11, 2023

(51) Int. Cl. E04F 21/16

(52) U.S. Cl. CPC E04F 21/162

(57) ABSTRACT

A notched trowel with an adjustable base plate that gives users in the construction industry the flexibility to utilize the same tool while applying building materials to substrates.

### CROSS-REFERENCE TO RELATED APPLICATIONS

Not Applicable.

### TECHNICAL FIELD

The present invention relates generally to the field of construction hand tools. More specifically, the present invention relates to a notched trowels that are used to apply a bonding material to a surface substrate.

### BACKGROUND

In the construction industry, a substrate refers to the surface upon which building materials are installed. During its installation, the substrate is covered with a bonding material and the building material is pressed against the bonding material to form a bond. By way of example, building materials such as tile may be affixed to substrates surfaces such as floors, countertops, walls, tables, and other surfaces by means of a bonding material such as cement, mortar, epoxy, or some other bonding adhesive.

The traditional application of the bonding material to the substrate is performed by applying the bonding material to a hand tool (i.e., a trowel), and then using that hand tool to spread the bonding material to the substrate evently. In order to create a successful bond where the building material has up 100 percent contact with the bonding material, a specific application process must be used which utilizes a notched trowel. Following the application of the bonding material to the trowel, the trowel is used to spread the bonding material across the substrate surface. The notched edge of the trowel is then used to make perpendicular or angular decreases in the bonding material surface to allow for maximum contact between the base of the building material and the surface of the bonding material. The perpendicular or angular decreases in the bonding material allow for the bonding material to adhere to any present uneven areas of the building material and minimized the risk of trapping air between the building material and the substate surface.

Notched trowels that are currently used in the industry typically comprise of a top plate having notched edges, and a handle that is connected to the upper surface of the top plate. For those who are applying a bonding material in such a way that requires the need to be of different notch sizes, different trowels must be used. In addition, those who are lefthanded may have challenges with utilizing traditional notched trowel due to the location of the handle.

Disclosures such as U.S. Pat. No. 3,166,776 provide the foundational prior art upon which most notched trowels in use today rely on. While this disclosure teaches to a trowel having notched edges, it does not teach to a trowel having notched edges of varying sizes, or a separate notched plate.

Similarly, disclosures U.S. Pat. No. 4,958,399 generally teach to trowel assemblies having a notched base plate that is detachable from the top handle member. While this disclosure does provide for a trowel with a removable/detachable base, it does not teach to a trowel that allows for the base plate to be shifted from the left to the right or rotated 180 degrees.

Various attempts have been made to solve the problems which may be found in the related art but have been unsuccessful. A need exists for a notched trowel with an adjustable base plate, thereby giving users in the construction industry the flexibility to utilize the same tool while applying building materials to substrates.

### BRIEF SUMMARY OF THE INVENTION

Certain embodiments commensurate in scope with the original claims subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed in the present disclosure by name, such as substrate, building material, bonding material, hand tool, handle, notched, edge, and so forth, are herein meant to include or encompass all equivalents for such elements. Such equivalents are contemplated for each element named in its particular herein.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for an adjustable notched trowel. The general purpose of the present invention, which shall be described subsequently in greater detail, is to allow a user to spread a bonding material on a substrate surface without the need to switch tools.

The features of the invention which are believed to be novel and particularly pointed out and distinctly claimed in the concluding portion of the specification. These and other features, aspects, and advantages of the present invention will become better understood with reference to the following drawings and detailed description.

The present invention comprises of a top plate, a notched plate having notches with the size of at least 1/16″×⅛″ to ⅛″×¾″ on one left side and ⅜″×¼″ to ⅜″×1¼″ on the one right side, and a handle connected to the top surface of the top plate. In a preferred embodiment of the present invention, the top plate comprises of at least two narrow rectangular shaped slots that correspond to at least two stabilizing pegs that extend upward and perpendicularly from top surface of the notched plate.

In another preferred embodiment of the present invention, the slots in the top plate are located near the top side and bottom side of the top plate and on the opposite sides of the top plate handle. The slots are further configured to allow for the notched plate stabilizing pegs to slide through the corresponding slots thereby allowing for the base plate to slide to the left of the top plate when the left notched edge is to be used, and sliding to the right of the top plate when the right notched edge is to be used. The stabilizing pegs are secured in position in the slots by means of a screw, washer, bolt, or some other removable securing mechanism.

In alternative embodiments, the base plate may also rotate 180 degrees by means of a connecting member that is centrally located on the bottom of the top plate and can removably connect the connecting member on the top surface of the notched plate.

To operate the adjustable notched trowel, a user may loosen or remove the securing mechanism and slide the notched plate to the left or the right of the top plate. To resecure the notched plate, a user may tighten or reattached the securing mechanism.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

Numerous advantages and aspects of the invention will be apparent to those skilled in the art upon consideration of the following detailed description.

### DETAILED DESCRIPTION

While the invention will be described in connection with the construction industry and hand tools, it is understood that the invention is not limited in scope to use in the construction industry but may be used with objects having other configurations.

All dimensions specified in this disclosure are by way of example only and are not intended to be limiting. Further, the proportions described are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims and abstract, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. 112.

While the invention generally described herein has been disclosed in connection with a number of embodiments shown and described in detail, various modifications should be readily apparent to those of skill in the art.

What is claimed is:

1. An adjustable notched trowel for applying a bonding material to a substrate surface, comprising:
a top plate comprising a left edge, a right edge, a top surface comprising of at least two female rectangular slots, and a bottom surface comprising of a connection mechanism;
a notched plate having a left notched edge, a right notched edge, a top surface comprising of a connection mechanism and at least two male stabilizing pegs, and a bottom surface; and
a handle connected to the upper surface of the top plate.

2. The adjustable notched trowel of claim 1 where the left notched edge measures at least size of 1/16″×⅛″ to ⅛″×¾″ and the right notched edge measures at least ⅜″×¼″ to ⅜″×1¼″.

3. The adjustable notched trowel of claim 1 where the male stabilizing pegs of the notched plate are configured to coincide with the female rectangular slots to allow for the notched plate to remain flush with the top plate.

4. The adjustable notched trowel of claim 3 where the male stabilizing pegs are secured to remain connected through the female rectangular slots by means of a securing member such as a screw, bolt, washer, or other securing mechanism of the like.
